(19) United States
(12) Patent Application Publication
(10) Pub. No.: US 2009/0099861 A1
(43) Pub. Date: Apr. 16, 2009

(54) INGESTION AND DISTRIBUTION OF MULTIPLE CONTENT TYPES

(75) Inventors: IMRAN AZIZ, SEATTLE, WA (US); PHANINDRA S. KANUMURI, SNOQUALMIE, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/873,225

(22) Filed: Oct. 16, 2007

(51) Int. Cl. G06F 17/30; G06F 17/40; G06Q 99/00

(52) U.S. Cl. 705/1

(57) ABSTRACT

A content portal provides a single user interface for uploading content for distribution to various marketplaces. A user may create a user account with the content portal and upload content, which is stored by the content portal. The content may include a variety of different content types. The content portal may be used to manage the content and to distribute the content to a variety of marketplaces. The marketplaces may also return analytics to the content portal, which provides reports to the user regarding activities associated with the content at the marketplaces.

### BACKGROUND

The Internet has allowed users to share and access a continuously increasing amount of content. Currently, there are numerous marketplaces, which include a variety of web sites, web services, and connected applications, that allow users to upload content to either share or sell on the marketplaces. The various content types that a user may wish to share or sell include videos, music, classifieds, audiocasts, products, images, software, and electronic books, to name a few.

There are a wide variety of marketplaces that are typically directed towards or target a particular content type. For instance, video-sharing marketplaces have more recently become extremely popular and allow users to upload and share videos with other users. Similarly, photo-sharing marketplaces allow users to upload photos that they wish to share with other users. As another example, product marketplaces allow users to upload information regarding products they wish to sell.

Users often wish to share or sell multiple different types of content via the available marketplaces. However, because each marketplace is typically directed towards a single content type, users must separately upload their different content types to different marketplaces. Additionally, users may wish to share or sell content of a particular type on multiple marketplaces. However, because the marketplaces are typically owned or operated by separate entities and are not affiliated with one another, users generally must separately upload content to each of the various marketplaces servicing that type of content. Accordingly, in these cases, users are required to maintain accounts with the various marketplaces and must interact with each marketplace separately. Given the amount of content and the varying types of content that some users wish to share or sell, the requirement to maintain separate accounts with various marketplaces and individually upload content to the various marketplaces may be very cumbersome for users.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to a content portal that provides for ingestion of various content types and publishing the content types to various marketplaces. The content portal provides a single user interface for creating and managing content, publishing content to various marketplaces, and reporting analytics regarding the content from the various marketplaces. The content portal allows users to create or upload content and store the content at a single storage platform, from which the content may be managed. The content may be communicated from the content portal to a variety of different marketplaces. Additionally, analytics from the marketplaces may be returned to the content portal for reporting.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is a block diagram of an exemplary system in which embodiments of the present invention may be employed;

FIG. 3 is a block diagram of an exemplary content portal in accordance with an embodiment of the present invention;

FIG. 4 is a flow diagram showing a method for ingesting content at a content portal and distributing content to marketplaces in accordance with an embodiment of the present invention;

FIG. 5 is an illustrative screen display of an exemplary user interface providing a user's home page for a content portal in accordance with an embodiment of the present invention;

FIG. 6 is an illustrative screen display of an exemplary user interface allowing a user to add content information for content to be uploaded to a content portal in accordance with an embodiment of the present invention;

FIG. 7 is an illustrative screen display of an exemplary user interface allowing a user to select marketplaces for content in accordance with an embodiment of the present invention;

FIG. 8 is an illustrative screen display of an exemplary user interface allowing a user to search content items uploaded to a content portal in accordance with an embodiment of the present invention; and

FIG. 9 is an illustrative screen display of an exemplary user interface allowing a user to view and edit information associated with a content item at a content portal in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed towards a content portal that provides a single user interface for users to upload content of any of a variety of content types and to distribute the content to multiple marketplaces. As used herein, the term “content” or “content item” are used interchangeably to refer to any type of content a user may wish to share or sell on a marketplace. The content may include digital content, such as videos, images, music, audiocasts and electronic books. Additionally, the content may include information regarding a product or classified that a user wishes to publish to a marketplace. In some cases, content may include associated information or metadata that may be used to describe the content to facilitate publishing the content on marketplaces. As used herein, the term “marketplace” includes a website intended for sharing and/or selling user content.

In accordance with embodiments of the invention, users may upload content to the content portal, which stores the uploaded content. The content portal may be configured to accept a variety of different content types. Once content has been uploaded, the user may manage the content at the content portal. Additionally, the content may be published from the content portal to a variety of different marketplaces that may each be owned and/or operated by separate entities. The marketplaces may collect analytics regarding the user's content and provide the analytics back to the content portal. Accordingly, the user may access analytics regarding the user's content from the various marketplaces at the content portal.

Accordingly, in one aspect, an embodiment of the invention is directed to one or more computer-readable media embodying computer-useable instructions for performing a method. The method includes receiving, at a content portal, a number of content items for a user. The content items include a number of content types. The method also includes communicating at least a portion of the content items from the content portal to a number of marketplaces.

In another embodiment, an aspect of the invention is directed to a system of one or more computing devices including a processor and computer-readable media for providing a content portal. The system includes a user interface component that interfaces with a user device. The system also includes an ingestion module that receives a number of content items from the user device. The content items include a number of content types. The system further includes a distribution module that distributes at least a portion of the content items to a number of marketplaces.

A further aspect of the invention is directed to a method for providing a content portal to a number of marketplaces. The method includes creating a user account at the content portal. The method also includes receiving, at the content portal, a number of content items from a user device and associating the content with the user account. The content items include a number of content types. The method further includes distributing at least a portion of the content items from the content portal to the marketplaces based at least in part on content type. The method still further includes receiving, at the content portal, analytics from at least a portion of the marketplaces and associating the analytics with the user account.

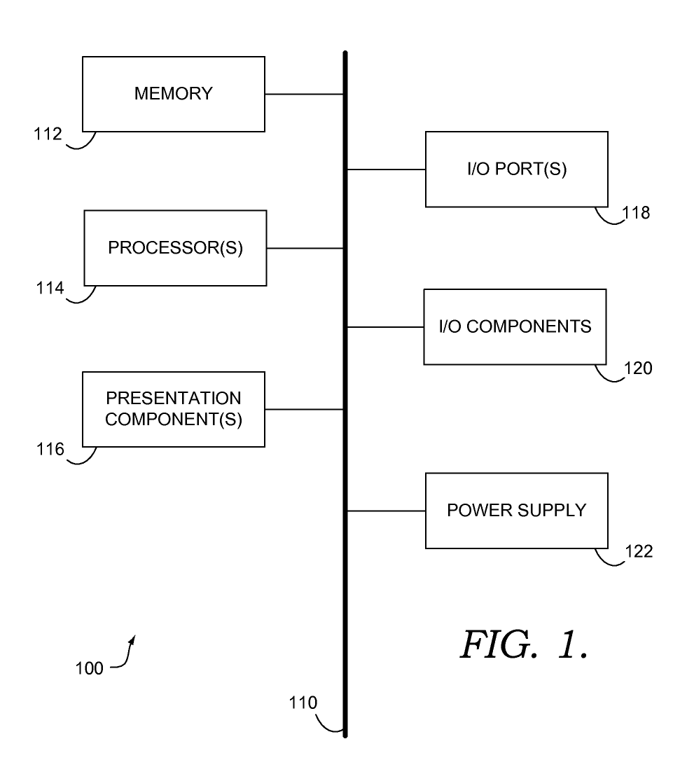

Having briefly described an overview of the present invention, an exemplary operating environment in which various aspects of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example only and not limitation, computer-readable media includes both volatile and nonvolatile, removable and non-removable media implemented in any method or technology for storage of information such as computer-readable instructions, data structures, program modules or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

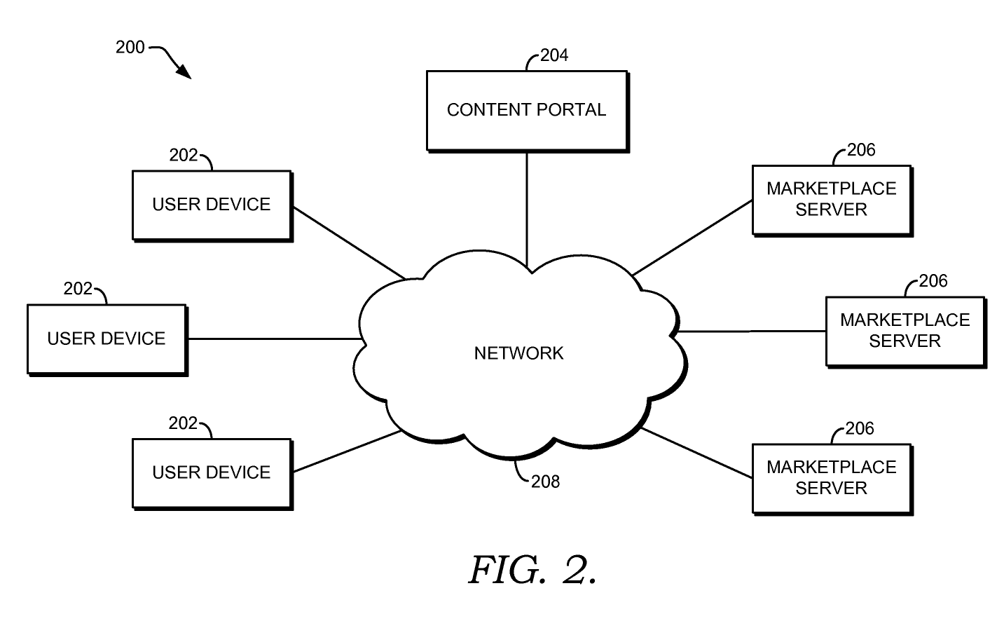

Referring now to FIG. 2, a block diagram is provided illustrating an exemplary system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 200 may generally include a number of user devices 202, a content portal 204, and a number of marketplace servers 206. Each of the components of the system 200, including the user devices 202, content portal 204, and marketplace servers 206 may comprise any type of computing device, such as the computing device 100 described with reference to FIG. 1, for example. The components with the system 200 may communicate with each other via a network 208, which may include, without limitation, one or more local area networks (LANs) and/or wide area networks (WANs). Such networking environments are commonplace in offices, enterprise-wide computer networks, intranets, and the Internet. It should be understood that any number of user devices, content portals, and marketplace servers may be employed within the system 200 within the scope of the present invention. Additionally, although many other components of the system 200 are not shown, those of ordinary skill in the art will appreciate that such components and their interconnections are well known. Accordingly, additional details concerning components not shown in the system 200 are not further disclosed herein.

Users may store a variety of digital content on their user devices 202 or otherwise have products they wish to share or sell using marketplaces provided by the marketplace servers 206. The marketplace servers 206 generally include one or more servers that facilitate a marketplace at which users may share or sell content, such as, for instance, videos, music, classifieds, audiocasts, products, images, software, and electronic books. As discussed previously, users traditionally would need to separately upload the different content types from their user devices 202 to the various marketplaces 206.

In accordance with the embodiment of FIG. 2, a content portal 204 is provided for facilitating users' interactions with the various marketplace servers 206. Generally, the content portal 204 may include one or more computing devices (such as the computing device 100 of FIG. 1) that allow users to upload, store, manage, and publish their content to multiple marketplace servers 206. Although the content portal 204 is shown as a single device in FIG. 2, it should be understood that multiple devices may operate in a distributed computing environment to provide the content portal. Any and all such variations are contemplated to be within the scope of embodiments of the present invention.

The content portal 204 provides a single user interface that allows users to upload, store, manage, and publish their content to the marketplace servers 206. Users may employ their user devices 202 to access the content portal 204 and upload their content. The content is then stored by the content portal 204, and users may manage the stored content.

An interface is provided between the content portal 204 and each of the marketplace servers 206. As such, the content portal 204 may publish a user's content to various marketplace servers 206, which in turn make the content available on their marketplaces to other users. Marketplaces typically track various analytics associated with users' content. For instance, marketplaces may track information such as user ratings, product ratings, click-through rates, item views, conversion rates, revenue, payment information, and the like. The analytics may be provided from the marketplace servers 206 to the content portal 204, which collects the analytics and provides reports to the users.

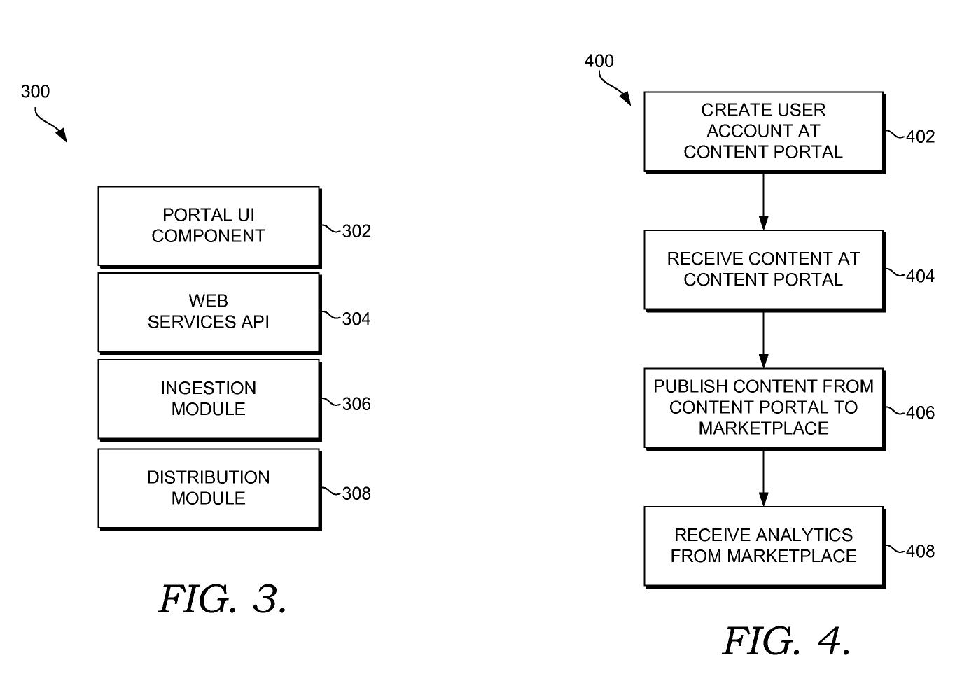

Turning to FIG. 3, a block diagram is provided showing an exemplary content portal 300 in accordance with an embodiment of the present invention. The content portal 300 generally includes a portal user interface component 302, web services APIs 304, an ingestion module 306, and a distribution module 308.

The portal user interface component 302 is a front-end tier that provides a user interface allowing users to interact with the ingestion module 306 and distribution module 308 via the web services APIs 304 to manage their accounts and content. The portal user interface component 302 allows users to upload content for storage by the content portal 300 and to manage the uploaded content. Additionally, the portal user interface component 302 allows users to publish content from the content portal 300 to multiple marketplaces. The portal user interface component 302 accesses the underlying web services APIs 304 built on top of the ingestion module 306 and distribution module 308 to communicate with the underlying components.

The ingestion module 306 enables a variety of functions including identification, extraction, tagging, storage, scrubbing, aggregation, and analytics on users content. First, the ingestion module 306 provides identification for a user and for a user's content. User identification can include requiring a user to create an account and sign in each time the content portal 300 is accessed by the user. Smart user identification may be employed to restrict users or domains that do spamming or are otherwise blacklisted. Content identification may include identifying content uploaded by a user as a particular content type. Scrubbing may be employed to identify malicious content and verify other content isn't malicious.

Information may be extracted for content such that tags and other metadata describing the content may be associated with the content. In some cases, information may automatically be extracted for content, for instance, by accessing information from the user's device or from a third-party source, such as a web server. In other cases, the system may prompt the user via the portal user interface component 302 to provide information describing the content.

Content and its associated information is stored by the content portal 300. For instance, the content may be stored as objects and associated metadata. In some embodiments, the ingestion module 306 aggregates content by content type and across sources. The ingestion module 306 also associates analytics received from marketplaces with content and makes the analytics available to users via the portal user interface component 302.

The distribution module 308 enables content and associated information to be distributed to marketplaces. An interface may be provided between the distribution module 308 and each affiliated marketplace that allows content to be published to the marketplace. Content may be published to a marketplace, for instance, by transferring the content as an object and associated metadata in accordance with each marketplace's requirements.

Turning now to FIG. 4, a flow diagram is illustrated that shows a method 400 for ingesting content at a content portal and distributing content to marketplaces in accordance with an embodiment of the present invention. Initially, as shown at block 402, a user signs up for an account with a content portal. Account creation may include a number of measures to prevent spammers and other malicious users. For instance, account creation may include features to prevent automated account creation by bots. In some embodiments, a white list and/or blacklist may be maintained for verifying users.

When creating a content portal account for a user, the content portal may request user information that is then used to create accounts for the user at various marketplaces. In some cases, however, the user may have existing accounts with one or more marketplaces. Accordingly, when a user account is created for the content portal, the user may be asked to provide marketplace account information by the content portal, which associates the information with the user account and may employ the information when publishing content to marketplaces and receiving analytics from marketplaces.

After a content portal account is created for a user, the content portal receives content, as shown at block 404. Content may be provided to the content portal in a number of different ways in various embodiments of the invention. By way of example only and not limitation, in one embodiment, the user may select digital content stored on a user device and upload the content to the content portal. In another embodiment, a user may create a content item using a user interface provided by the content portal. For instance, in the case a user wishes to sell a product on product marketplaces, the user may provide information regarding the product (e.g., product description, image, etc.) which is used to create the content item for the product. In further embodiments, documents may be crawled to identify content items. For instance, a user may own a small business, which maintains web pages having products offered by the business. The web pages could be crawled to identify products and generate content items. In some embodiments, content items may be imported from a document, such as a spreadsheet document or XML document. For instance, a user owning a small business may maintain a catalog or other product list that may be provided to the content portal for creating content items.

In some embodiments, a content type is identified for each content item provided to the content portal. In some cases, the content type may be identified automatically by the content portal. For instance, the content type may be identified based on a file type such as a video file being identified as a video content type. In other cases, the user may identify the content as a particular content type. Additionally, further information describing a content item may be associated with the item. Information associated with a content item may vary based on the content type. For instance, a music content item may have associated information such as artist and genre while a product content item may have associated information such as price and availability. In some embodiments, content items may be organized and grouped by the content portal based on system-generated and/or user-generated information. For instance, all content items of a particular content type may be grouped together. In some embodiments, content items may be scrubbed to identify and remove any malicious content.

After a content item has been received by the content portal, the content item and its associated information is stored. A content item that has been stored by the content portal but has not yet been published to a marketplace is considered to be pending. Stored content and its associated information may be modified and managed by the user be employing a user interface provided by the content portal.

As shown at block 406, stored content items may be published to one or more marketplaces. In some embodiments, marketplaces may be selected automatically based on content type. In other embodiments, one or more rules may be established by a user and/or the content portal to select marketplaces for content items based on a variety of factors in addition to or in lieu of content type. For instance, a user may establish a rule that content items having a particular tag being published to a specified set of marketplaces. In further embodiments, a user may manually select one or marketplaces for a given content item. Any and all such variations are contemplated to be within the scope of embodiments of the present invention.

In some cases, marketplace-specific information may be required when a content item is published to a given marketplace. For instance, different marketplaces may require different information to be provided for a content item. Accordingly, the content portal may be configured to provide the marketplace-specific information from the metadata associated with a content item if the information is available. Otherwise, the content portal may prompt the user to provide the information.

As indicated previously, a user may manage content uploaded to the content portal. In some embodiments, if a user modifies a content item after it has been published to one or more marketplaces, the modified information may be provided to the applicable marketplace(s) to update the content item on those marketplace(s). Additionally, the user may modify the marketplaces at which a content item is published, for instance, by adding or removing marketplaces.

Each marketplace may collect a variety of statistics for a given content item. The statistics collected for a content item may vary based on content type and from marketplace to marketplace and may include, for instance, user ratings, product ratings, click-through rates, item views, conversion rates, revenue, and payment information. As shown at block 408, analytics may be provided from the various marketplaces to the content portal and reported to a user via a user interface provided by the content portal. Marketplace analytics may be provided to a user on a per-marketplace basis and/or the analytics may be aggregated and provided to the user.

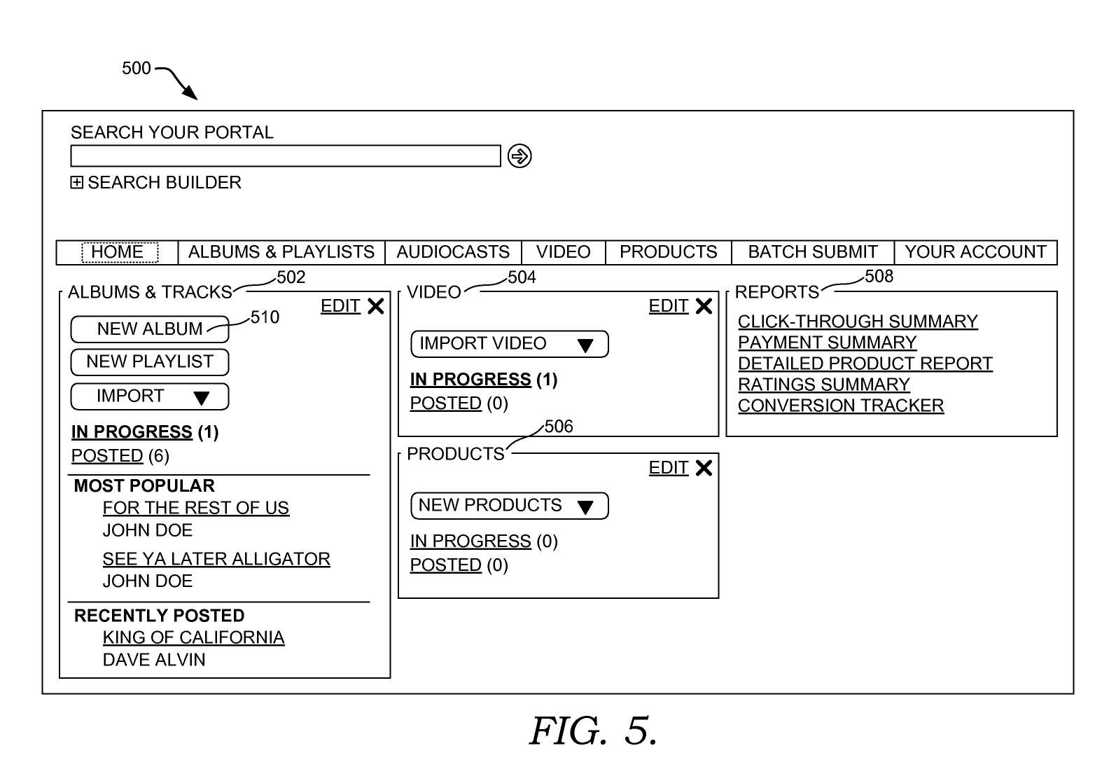

Embodiments of the present invention will now be described with reference to FIGS. 5-9, which include exemplary screen displays of a user interface provided by a content portal. It will be understood and appreciated by those of ordinary skill in the art that the screen displays of FIGS. 5-9 are provided by way of example only and are not intended to limit the scope of the present invention in any way.

Referring initially to FIG. 5, a screen display 500 is provided illustrating an exemplary home page provided by a content portal in accordance with an embodiment of the present invention. Generally, when a user accesses the content portal, the user logs into the service to access his/her account. After the user logs in, a home page such as that shown in FIG. 5 may be provided.

As shown in FIG. 5, the user's content may be grouped by content type. For instance, the user interface includes areas for the following content types: albums and playlists 502, video 504, and products 506. It should be understood that the content types shown on the home page of FIG. 5 are provided for illustrative purposes only and other content types may be included. By employing the user interface, the user may add and manage content on the content portal and publish content to various marketplaces.

The home page also includes a reports area 508 that allows the user to access analytics regarding content provided to various marketplaces. For instance, the user may be able to access a click-through summary, payment summary, detailed product report, ratings summary, and conversion tracker, as well as other information provided to the content portal by various marketplaces.

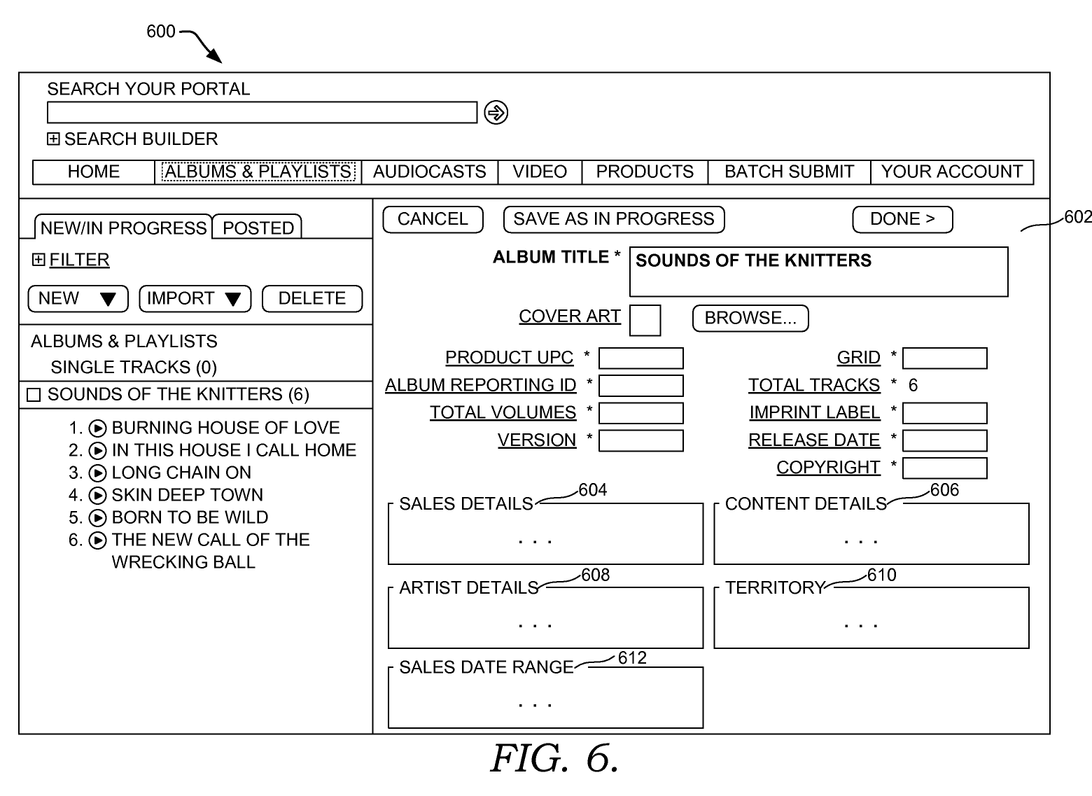

When a user wishes to add new content, the user may select the appropriate content type to be uploaded. For instance, if the user wishes to add a new album, the user may select the “New Album” button 510. When the “New Album” button 510 is selected, a user interface such as that shown in the screen display 600 of FIG. 6 may be provided. The user may add a variety of information regarding the album, including, for instance, album information 602, sales details 604, content description 606, artist details 608, territory 610 , and sales date range 612. In some cases, the information may be imported without requiring the user to input the information. It should be noted that the information that may be provided and viewed via a user interface such as that shown in the screen display 600 may vary widely.

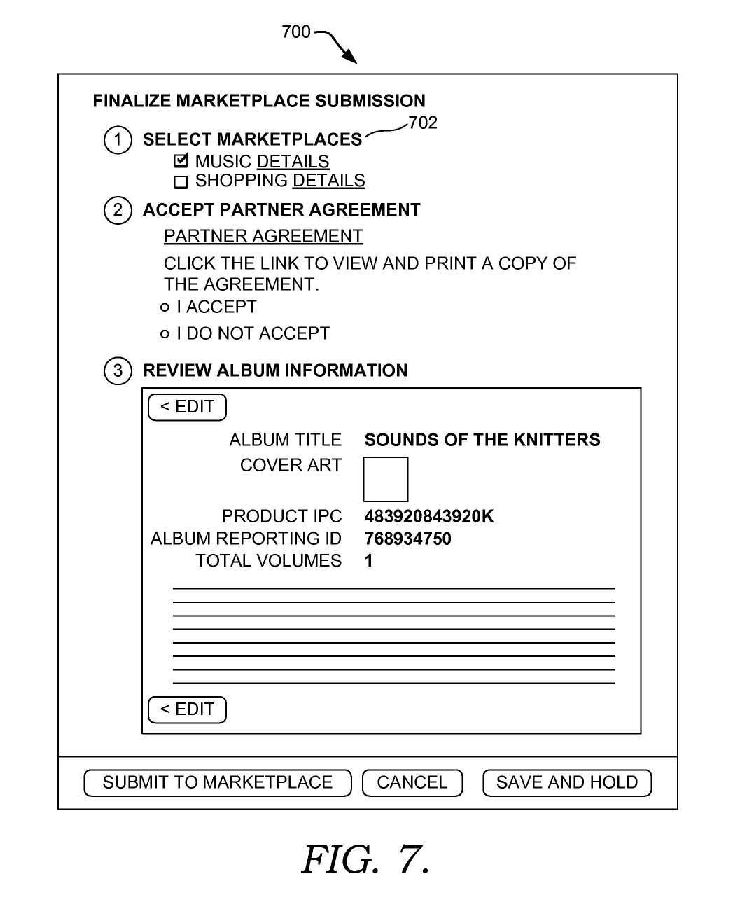

After the user finishes entering information associated with the new album, the user may select to publish the album to one or more marketplaces. For instance, the screen display 700 of FIG. 7 illustrates a user interface for finalizing submission of content to marketplaces. The user interface includes an area 702 that allows users to select marketplaces for content submission. In some embodiments, all available marketplaces may be displayed in the user interface for possible selection by the user. In other embodiments, marketplaces may be filtered based on content type. For instance, if the content is a music album, only music-sharing and product marketplaces may be presented for selection while other types of marketplaces (e.g., video-sharing marketplaces) may be removed. The user may select one or more marketplaces and cause the content portal to publish the content to the selected marketplaces. The content is then available at those marketplaces for other users to consume.

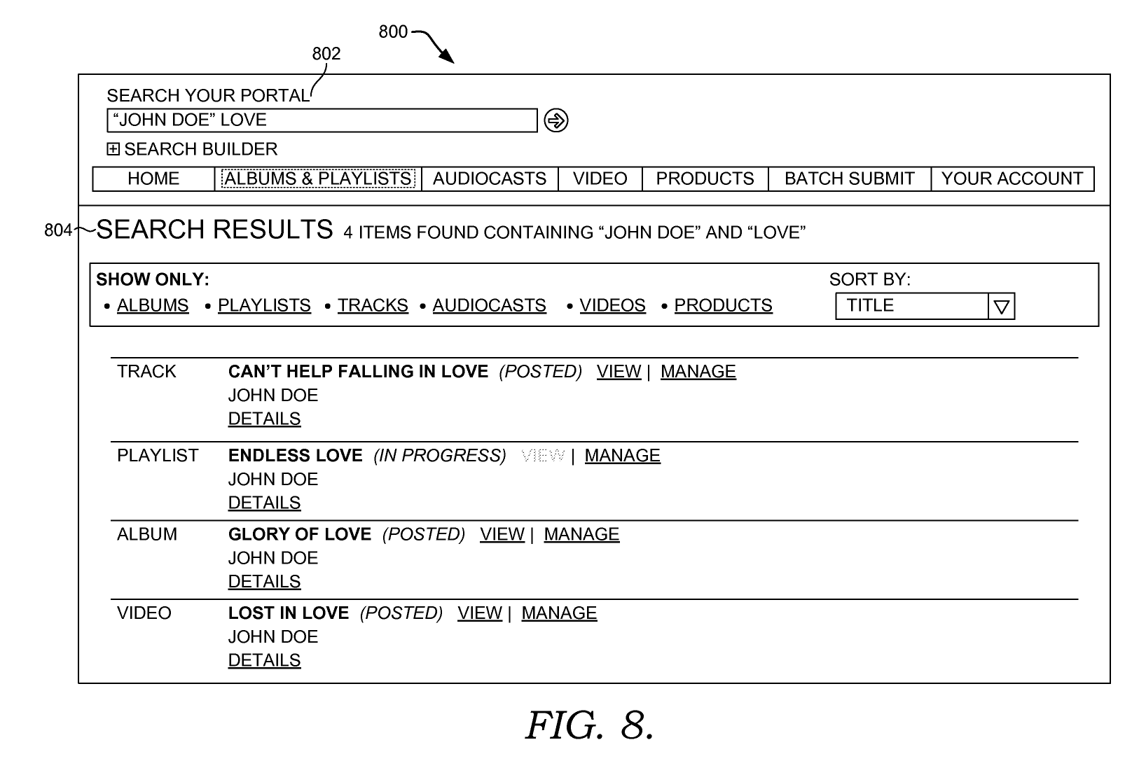

The user interface provided by the content portal may include a number of functions for allowing a user to manage the uploaded content. For instance, as shown in the screen display 800 of FIG. 8, a search function 802 may be provided that allows the user to search for various content items. In the illustrated example, the user has entered the search terms {“John Doe” Love}, which has resulted in four items being identified in the search results area 804, including a track, a playlist, an album, and a video.

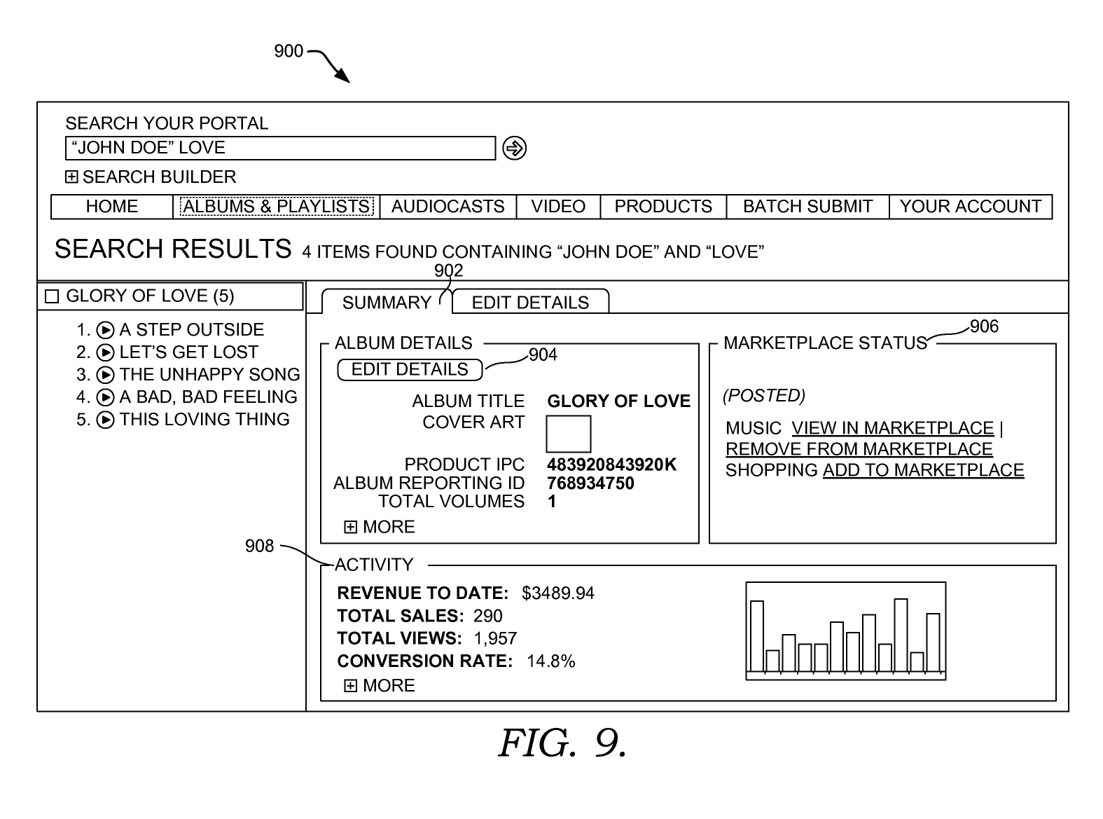

The user may select one of the content items to view information associated with the content item and modify the information as desired. For instance, suppose the user selects the album “Glory of Love” from the search results 804. After selecting the item, a user interface such as that shown in the screen display 900 of FIG. 9 may be provided. Summary information 902 is provided for the selected item. In the present example in which the selected item is an album, album details are presented. The user may choose to edit the album information by selecting the “Edit Details” button 904. In addition to summary information 902 for the content item, marketplace status 906 may be provided to indicate the marketplace(s) at which the content has been published. Additionally, the marketplace status area 906 includes options to add or remove the content from various marketplaces. Activity information 908 may also be provided for the content item. The activity information includes statistics collected by the marketplaces for the content item and provided to the content portal. In various embodiments, the activity information may be provided for individual marketplaces and/or may be provided for each individual marketplace.

Embodiments of the invention will not be further illustrated below with specific examples of how users may interact with a content portal.

### Music Scenario

Garrett is a local garage band owner who wants to promote his band called “Scissors.” He opens an account with a content portal in accordance with an embodiment of the present invention. After accessing the service, he finds that he can upload and share his music with multiple music-sharing marketplaces. Accordingly, he creates a listing of his latest album and adds tracks to the album. The service then distributes the album to a variety of music-sharing marketplaces. Garret also notices that he can upload a music video of his band to the content portal, which then distributes the video to multiple video-sharing marketplaces. Garrett further notices he can sell his band memorabilia in shopping marketplaces using the content portal. He uploads information regarding the memorabilia to the service, which then distributes the information to multiple product marketplaces. Accordingly, the content portal has provided a convenient way for Garret to promote his band by distributing music, videos, and products associated with the band to various marketplaces at which users may access the content.

### EBooks Scenario

Susie is a short story writer who writes great romantic novels. She wants to earn money by publishing her novels in electronic books format and make them available for end-users to download for cost. Susie signs up to a content portal and uploads her novel and provides information and keywords about the novel she uploaded, so that users can find it easily. She also notices there is a way she can name the price for this book.

Susie spends a few minutes to provide the necessary information and submits the e-books to various marketplaces using the content portal. Susie also notices that the ingestion/distribution service allows her to record an audio file about her novel. She is excited about this and selects to record a live audiocast using her computer microphone and saves it along with the e-book she uploaded.

After the first week, Susie wishes to see how her novel is doing with the audience. She logs in to the content portal and sees the activity on her book from the various marketplaces. She notices over 10,000 people read the preface of her novel for free and 1000 people actually bought the novel. She also notices over 5000 people downloaded the audiocast of her novel. She also has access to reviews users wrote about her novel. She is able to do all these things from a single user interface without worrying about upload, storage and manage activities at various marketplaces.

### Images Scenario

Rob is a freelance journalist/photographer who has great images and video from his recent trip to Iraq. He signs up to a content portal and uploads all the images he shot, and the service automatically gets the tags he attached to images to describe them. Rob also notices that there is a option to upload the video footage and provide a audio transcript. He uploads the video along with the photos and records the audio transcript. Rob notices that he can enable this content in various market places. He is amazed to see how simple it is for him to manage and store all these files and at the same time how easy to share these files across various market places and earn revenue.

### Video Scenario

John is a video enthusiast and has a substantial collection of personal videos, including video of an air-show that he wants to share with everyone for free. He also wants to upload his home video of a friend's birthday party onto his personal webspace so that his friends can view the video at any time. John finds that a content portal offers a way to do the both actions at the same time. He sets up a user account and uploads the videos using the video upload tool. He also finds that there is an option to write a transcript and provide metadata with the videos to describes the videos such that users can easily find them.

After successfully uploading the videos, John sees there is an option to enable his videos in various marketplaces for free or for a fee. He decides he wants to make his air show video for free for anyone on several video-sharing marketplaces. He also notices there is an option to publish his friend's birthday party video to his webspace. He submits the webspace name or URL and provides a username and password for the webspace.

John notices his personal video got published immediately and his air show video is waiting for verification. After couple of hours, he receives an email indicating that his video is successfully verified and available to everyone. John goes to one of the video-sharing marketplaces and searches for his air show video. He notices his video is appearing along with other videos that matched his keyword search.

### Shopping Scenario

Stephan is an owner of local furniture store called GEMS who wants to promote his local store in on shopping marketplaces. He finds that a content portal has a program in which he can become partner. He asks his channel manager Cheryl to signup and upload GEMS catalog. Cheryl signs up to the service using a simple signup form. She notices there are various options to create a catalog, including uploading an spreadsheet-based flat file, web based UI, and by having the service crawl documents. She also notices there is comprehensive help provided that assists her.

Since GEMS furniture doesn't have any online presence and their inventory is more than 10,000 items she thinks submitting a catalog in a spreadsheet is an easy approach. She thinks Miyagi in her staff can take care of this and she creates an account for him in the service and delegates the catalog upload process to him. Miyagi receives an email invite from Cheryl and he creates a login/password. He notices that the system automatically assigns his login to GEMS partner account. He creates the catalog and uploads it successfully to the service. The content portal then distributes the catalog to various shopping marketplaces.

As can be understood, embodiments of the present invention provide a content portal that facilitates users interactions with marketplaces by providing a single user interface that allows user to upload, manage, and store content at the content portal and to publish content from the content portal to multiple marketplaces. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-readable media embodying computer-useable instructions for performing a method comprising:
receiving, at a content portal, a plurality of content items for a user, the plurality of content items including a plurality of content types; and
communicating at least a portion of the content items from the content portal to a plurality of marketplaces.

2. The one or more computer-readable media of claim 1, wherein the content types include one or more of the following: video, music, classified, audiocast, product, image, software, and electronic book.

3. The one or more computer-readable media of claim 1, wherein the method further comprises:
creating a user account at the content portal for the user; and
associating the plurality of content items with the user account.

4. The one or more computer-readable media of claim 3, wherein creating a user account comprises receiving user information associated with the user for creating the user account at the content portal.

5. The one or more computer-readable media of claim 4, wherein the user information includes information associated with one or more user accounts for the user for at least a portion of the plurality of marketplaces.

6. The one or more computer-readable media of claim 4, wherein the method further comprises creating a user account for the user for at least one of the plurality of marketplaces using the user information.

7. The one or more computer-readable media of claim 1, wherein receiving, at the content portal, the plurality of content items includes one or more of the following: receiving digital content uploaded from a user device to the content portal; receiving information from the user for creating a content item; crawling one or more documents to identify content items; and importing content items from one or more documents.

8. The one or more computer-readable media of claim 1, wherein the method further comprises associating information with each of the content items.

9. The one or more computer-readable media of claim 8, wherein the information associated with each of the content items includes a content type.

10. The one or more computer-readable media of claim 1, further comprising determining a selection of one or more of the plurality of marketplaces for at least one content item.

11. The one or more computer-readable media of claim 10, wherein determining the selection comprises at least one of the following: determining the selection automatically based on a content type for the at least one content item; determining the selection based on one or more rules established for selecting marketplaces for content items; and determining the selection based on a manual user selection of one or marketplaces for the at least one content item.

12. The one or more computer-readable media of claim 1, wherein the method further comprises:
receiving, at the content portal, a modification of a content item previously received at the content portal; and
communicating the modification to one or more marketplaces to which the content item was previously communicated.

13. The one or more computer-readable media of claim 1, wherein the method further comprises:
receiving, at the content portal, analytics from at least a portion of the marketplaces; and
communicating the analytics for presentation on a user device associated with the user.

14. A system of one or more computing devices including a processor and computer-readable media for providing a content portal, the system comprising:
a user interface component that interfaces with a user device;
an ingestion module that receives a plurality of content items from the user device, the plurality of content items including a plurality of content types; and
a distribution module that distributes at least a portion of the content items to a plurality of marketplaces.

15. The system of claim 14, further comprising a data store for storing the plurality of content items and associated information.

16. The system of claim 14, wherein the distribution module determines a selection of one or more of the plurality of marketplaces for at least one content item.

17. The system of claim 16, wherein the distribution module determines the selection by at least one of the following: determining the selection automatically based on a content type for the at least one content item; determining the selection based on one or more rules established for selecting marketplaces for content items; and determining the selection based on a manual user selection of one or marketplaces for the at least one content item.

18. A method for providing a content portal to a plurality of marketplaces, the method comprising:
creating a user account at the content portal;
receiving, at the content portal, a plurality of content items from a user device and associating the content with the user account, wherein the plurality of content items include a plurality of content types;
distributing at least a portion of the content items from the content portal to the plurality of marketplaces based at least in part on content type; and
receiving, at the content portal, analytics from at least a portion of the plurality of marketplaces and associating the analytics with the user account.

19. The method of claim 18, wherein the method further comprises aggregating the plurality of content item at the content portal based on content type.

20. The method of claim 18, wherein the method further comprises facilitating user management of the plurality of content at the content portal.
